(19) United States
(12) Patent Application Publication
(10) Pub. No.: US 2017/0198500 A1
(43) Pub. Date: Jul. 13, 2017

(54) CLOSING DEVICE FOR CLOSING DOOR-LEAFS OF DOORS OR WINDOWS

(71) Applicant: MASTERLAB S.R.L. UNIPERSONALE, Conversano (BA) (IT)

(72) Inventor: Michele LOPERFIDO, Castellana Grotte (BA) (IT)

(21) Appl. No.: 15/315,255

(22) PCT Filed: Jun. 10, 2015
(86) PCT No.: PCT/IB2015/054384

§ 371 Date: Nov. 30, 2016

(30) Foreign Application Priority Data
Jun. 10, 2014 (IT) MI2014A001060

(51) Int. Cl. E05B 63/00; E05B 15/02; E05B 65/08

(52) U.S. Cl. CPC E05B 63/0056; E05B 65/0864; E05B 15/0205

(57) ABSTRACT

A closing device for closing door-leafs of doors or windows is disclosed which has a plate or rod body, associated with the frame which delimits a door-leaf and which is connectable to maneuvering means, and a closing member, which is fixed to the plate or rod body and adapted to be coupled with a corresponding abutment body fixable to the fixed framework of the door or window or to the frame which delimits another door-leaf of the door or window. The closing member has a shank which is fixable to the plate or rod body and a stud body which is coupled to the shank through coupling means which allow adjusting the position of the stud body along the longitudinal axis of the shank, wherein the stud body is adapted to be coupled with a corresponding seat in the abutment body.

The present invention regards a closing device for closing door-leafs of doors or windows.

Closing devices for closing door-leafs of doors or windows comprising one or more studs, each of which defines a respective so-called “closure point”, which are fixed to plates or rods which are slidingly mounted along the sections constituting the frame which delimits a door-leaf, are known. These plates or rods, are in turn connected to manoeuvring means controllable through a handle or the like.

On the fixed framework of the door-leaf or, in case of a door or window with two slidable or swing door-leafs, on the frame which delimits the other door-leaf, abutment bodies are fixed, one for each stud, in which an opening or a seat is obtained in which the corresponding stud is inserted or anyhow coupled for guaranteeing the door-leaf in the closure position of the door or window.

By acting on the handle or any other control member, the plates or rods on which the studs are fixed are slid between a first position, in which the studs are inserted or anyhow coupled in the respective seats of the corresponding abutment bodies, so as to secure the door-leaf in closure position, and a second position, in which the studs are disengaged or anyhow de-coupled from the respective seats of the corresponding abutment bodies, so as to allow the movement of the door-leaf for the opening of the door or window.

Often, due to errors concerning the manufacturing and/or mounting of the door-leaf and/or of the relative fixed framework and/or of the wall which receives the latter, there occurs studs positioning errors with respect to the corresponding abutment bodies. In particular, there are errors regarding the definition of the distance between each stud and the respective abutment body such to jeopardise the correct mutual insertion or coupling.

In order to eliminate these errors the use of spacers or thicknesses is known which are, for example, interposed between the fixed framework and the abutment bodies.

Thus, the mounting of these closure devices of the known type is particularly laborious and inaccurate.

An object of the present invention is to overcome the drawbacks of the prior art.

Within this general object, a particular object of the the present invention is to provide a closing device for closing door-leafs of doors or windows which allows adjusting the distance between each stud (“closure point”) and the respective abutment body so as to recover and eliminate manufacture and/or mounting errors of the door-leaf and/or of the relative fixed framework and/or of the wall, in a simple and easy manner.

Another object of the present invention is to provide a closing device for closing door-leafs of doors or windows which guarantees a stable and safe fixing of each stud (“closure point”) on the respective plate or rod.

Yet another object of the present invention is to provide a closing device for closing door-leafs of doors or windows with small overall dimensions, particularly easy to obtain and inexpensive.

These and other objects are obtained with a closing device for closing door-leafs of doors or windows as defined in claim 1.

Further characteristics of a closing device for closing door-leafs of doors or windows are defined in the dependent claims.

The characteristics and advantages of a closing device for closing door-leafs of doors or windows according to the present invention shall be more apparent from the following exemplifying and non-limiting example, with reference to the attached schematic drawings, wherein:

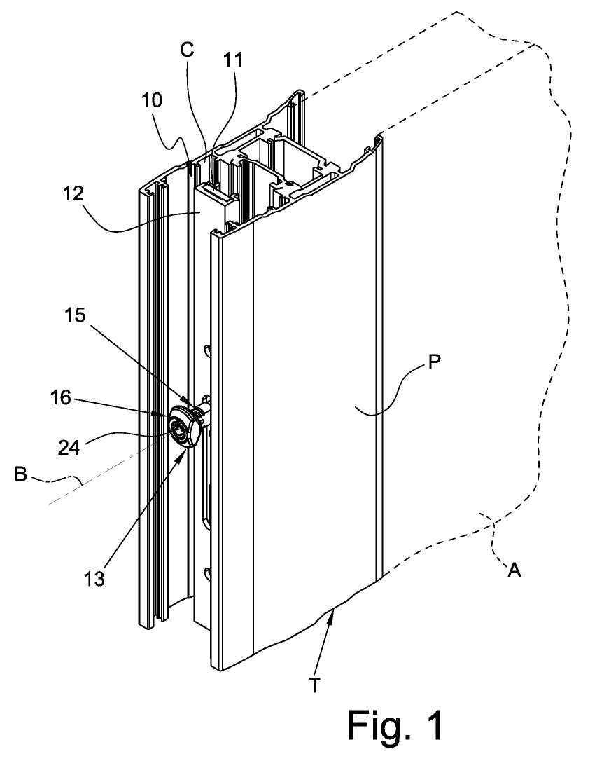

FIG. 1 is a schematic and axonometric view of a closing device according to the present invention in mounting configuration on a section constituting the frame which delimits a door-leaf of a door or a window;

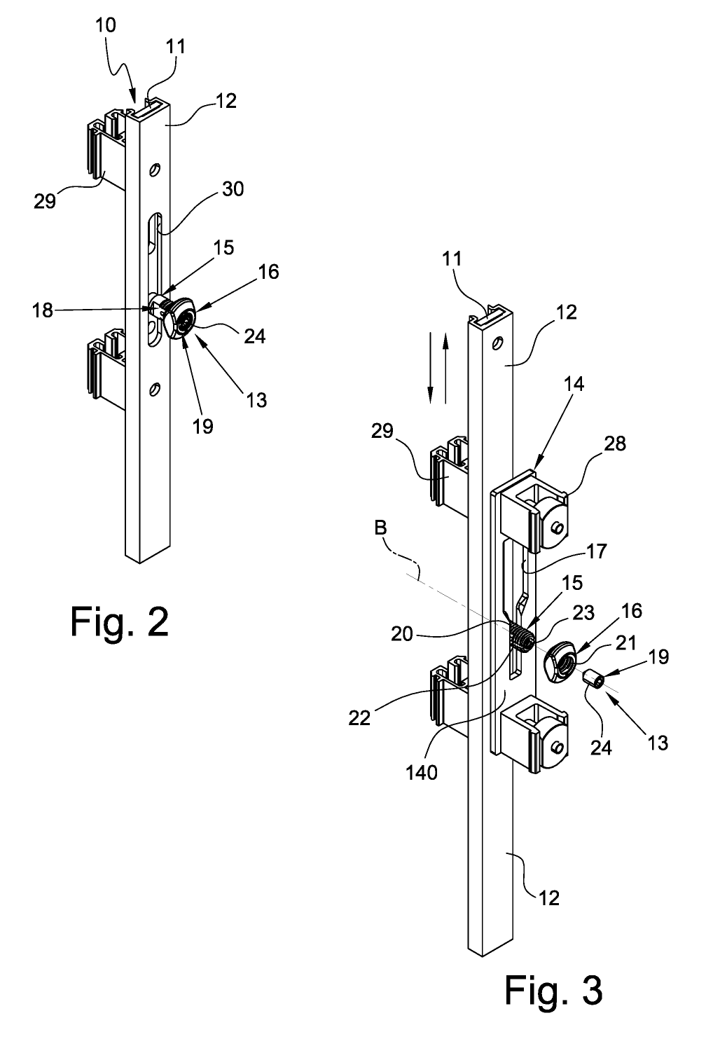

FIG. 2 is an enlarged scale view of a detail of FIG. 1;

FIG. 3 is a view of the detail of FIG. 2 in which the closing member is represented in a partly exploded view and in which the abutment body cooperating with the closing member is also shown;

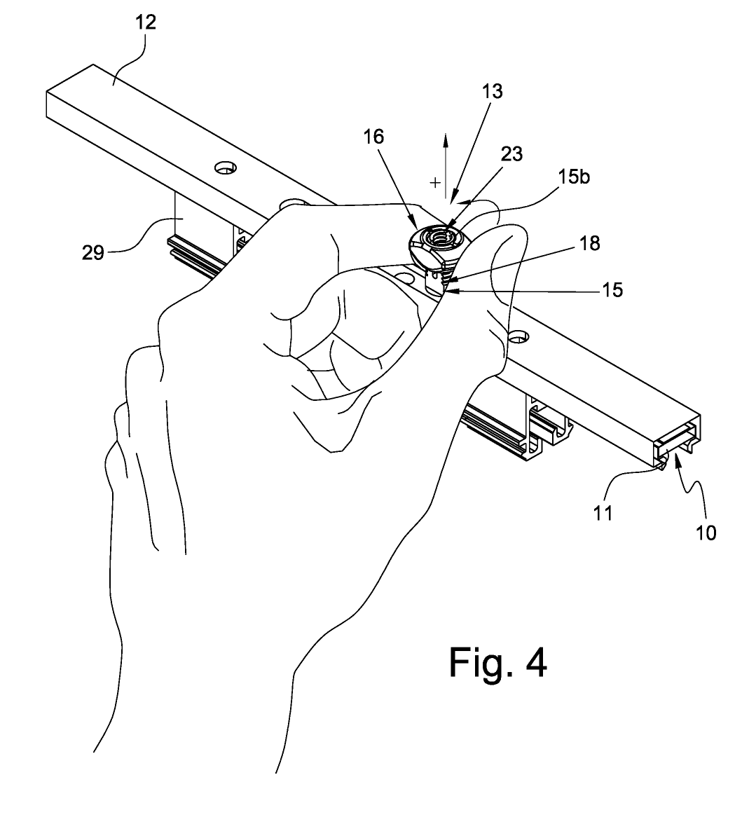

FIG. 4 schematically shows the step of adjusting the position of the stud body along the shank of the closing member of the closing device according to the present invention;

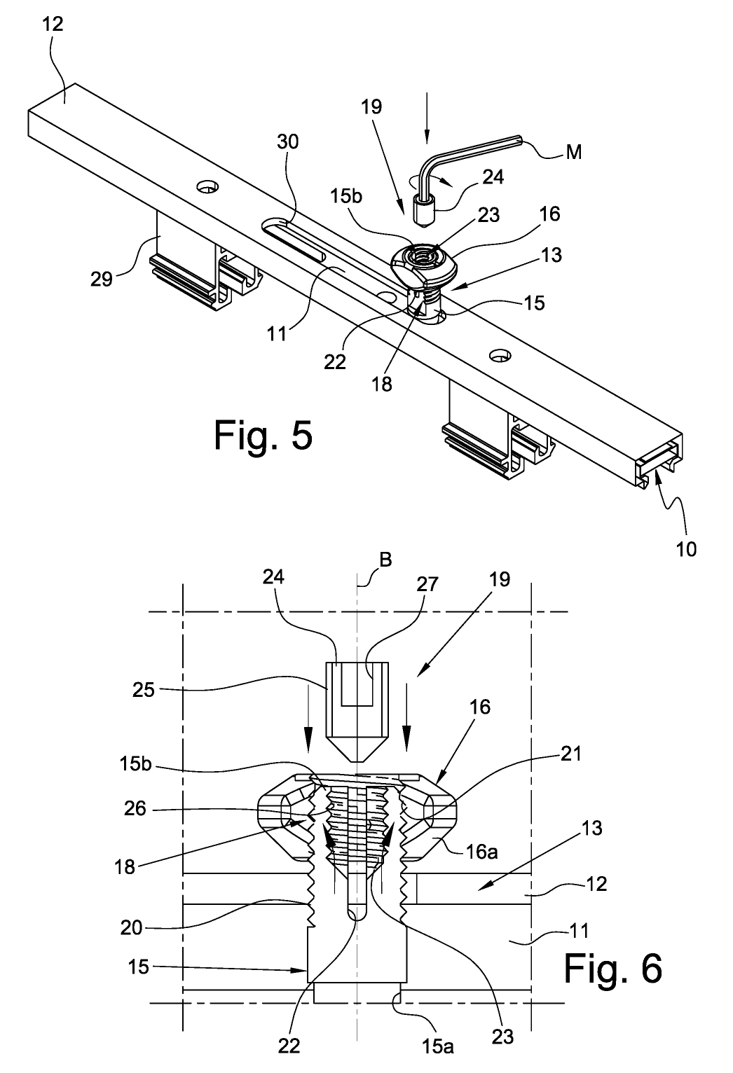

FIG. 5 schematically shows the subsequent step of locking the stud body with respect to the shank of the closing member of the closing device according to the present invention;

FIG. 6 is a sectional and enlarged scale view of the closing member of the closing device according to the present invention in the step of locking the stud body with respect to the shank;

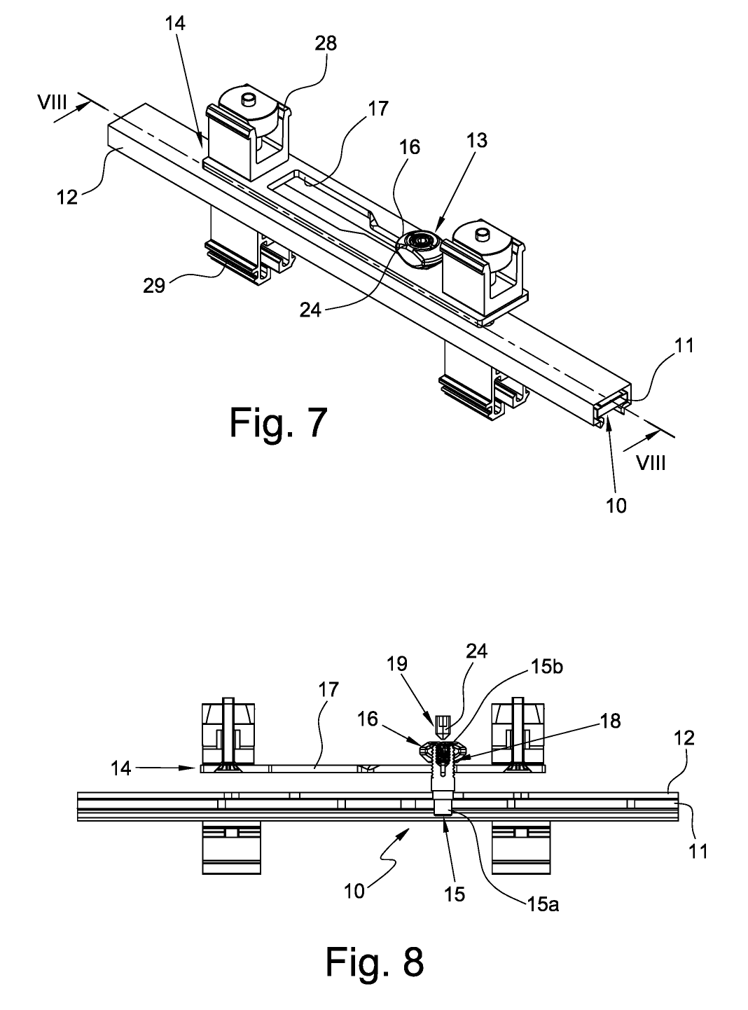

FIG. 7 is a view similar to that of FIG. 3 with the closing member in assembled configuration;

FIG. 8 is a section according to the plane VIII-VIII of FIG. 7 with the closing member in partly exploded view.

With reference to the attached figures a closing device for closing door-leafs A of doors or windows is indicated in its entirety with 10.

The closing device 10 according to the present invention is applicable to door-leafs A of any type such as, for example, slidable door-leafs, swing door-leafs, tiltable door-leafs.

The door-leaf A is delimited by a frame T.

The frame T may be constituted by sections P made of various materials and coupled to each other and enclose glasses or panels forming the door-leaf A.

As regards the present description, the expression “external edge” of the frame T is used to indicate the external peripheral portion of the frame T which, when the door-leaf A is in door or window closure position, faces and is adjacent to the intrados of the fixed framework which delimits the door or window—or, in case of doors or windows with two sliding door-leafs or with two swing-leafs, partly to the frame of the other door-leaf and partly to the intrados of the fixed framework—and which, such as for example represented in the attached figures, is defined by a channel of the section P.

In the attached figures, the door-leaf A and the frame T, or rather a section P constituting it, are only shown partly and schematically, given that they are not subject of the present invention, and thus will not be described further. Obviously, the shape of the frame T and the sections P forming it has no limitations as regards the present invention.

In addition, in the attached figures, the fixed framework of the door or window or the frame which delimits the other door-leaf of a door or window with two sliding or with two swing door-leafs are not shown, given that they are known to a person skilled in the art.

The closing device 10 comprises at least one plate or rod body 11 which can be associated in a movable manner to the frame T and which is connectable to manoeuvring means controllable through a handle or other control members and which are not represented being known to a person skilled in the art.

The plate or rod body 11 is, in particular, inserted in in a corresponding section of the frame T in a longitudinally slidable manner in both directions along it.

The plate or rod body 11 is, in particular, slidably housed in a containment and guiding body 12 in turn fixed in a channel C of the section P.

On the plate or rod body 11, at least one closing member 13 is fixed which is adapted to be coupled with a corresponding abutment body 14 fixable to the fixed framework of the door or window or to the frame which delimits another door-leaf of the door or window should the latter for example be of the two sliding or two swing door-leafs type.

The closing member 13 defines what is referred to in the industrial jargon as “closure point”. On the same plate or rod body 11 there may also be fixed two or more closure members 13. Analogously, the closing device 10 may also comprise more than one plate or rod body 11 as described above. That is, the closing device may be of the type with one or more “closure points”.

Each closing member 13 in turn comprises a shank 15 to which a stud body 16 is coupled which is provided with at least one projection or stud 16a which is adapted to be inserted in a corresponding seat 17 obtained in the abutment body 14 to obtain, cooperating with the latter, closing of the door-leaf A on the fixed framework or on the other door-leaf.

The shank 15 has a longitudinal axis B, a first end 15a and a second end 15b axially opposite to the first end 15a.

The first end 15a, or anyhow a section of the shank 15 proximal to the first end 15a, is fixed to the plate or rod body 11 for example with a threaded coupling, of the shape-coupling or force-coupling type, so that the longitudinal axis B of the shank 15 extends along a direction orthogonal to the plane on which there develops the plate or rod body 11.

Thus, when the closing device 10 is in mounting configuration on the frame T of a door-leaf A, the longitudinal axis B of the shank 15 extends on a plane parallel to the plane defined by the same door-leaf A, the plate or rod body 11 extending in a direction orthogonal to the plane defined by the door-leaf A. In such mounting configuration, at least the second end 15b of the shank 15 extends towards the external edge of the frame T so that, when the door-leaf A is in the configuration of closing the door or window, the stud body 16 or rather the stud 16a may be coupled with the corresponding seat 17 obtained in the abutment body 14.

According to the present invention, the stud body 16 is coupled to the shank 15 through coupling means 18 which allow adjusting the mutual relative position along the longitudinal axis B of the shank 15. As easily clear to a person skilled in the art, such adjustment allows modifying the distance between the stud body 16 and the abutment body 14 and, thus, between the stud 16a and the respective seat 17.

In addition, according to the present invention, locking and unlocking means 19 are provided for locking and unlocking the stud body 16 with respect to the shank 15—and, thus, of their relative position—the locking and unlocking means 19 being manoeuvrable by a user from outside the frame T which delimits the door-leaf A for example through a manoeuvre equipment M.

With the aim of facilitating the manoeuvring of the locking and unlocking means 19, the latter are defined coaxially to the shank 15 and they are accessible from the second end 15b thereof.

More in detail and with specific reference to the embodiment represented in the attached figures, the coupling means 18 are of the threaded type and comprise an external threading 20, i.e. obtained on the external lateral surface, of the shank 15 and with which a corresponding threading of an axial and passing through threaded hole 21 of the stud body 16 is engaged.

Thus, rotating the stud body 16 in one direction or the opposite one allows varying its position along the shank 15 and, thus, its distance with respect to the abutment body 14 and the seat 17 obtained therein.

The locking and unlocking means 19 allow stably locking the position of the stud body 16 with respect to the shank 15.

Advantageously, the locking and unlocking means 19 are of the expansion type.

With reference to the embodiment represented in the attached figures, the shank 15 is expandable radially and, for such purpose, it advantageously has one or more longitudinal grooves, slots or slits 22.

The shank 15 is then provided with an internal axial cavity 23 which is open at the second end 15b and in which there can be axially inserted a forcing member 24 adapted to force the radial expansion of the shank 15 so as to lock it in the stud body 16.

The end of the cavity 23 facing towards the first end 15a of the shank 15 is conical with conicity converging towards the first end 15a.

The forcing member 24 is constituted by a dowel screw with conical tip which is inserted into the internal axial cavity 23 through the opening defined at the second end 15b.

The dowel screw has an external threading 25 which is engaged with a corresponding threading 26 inside the cavity 23, i.e. the threading 26 is obtained on the lateral walls which delimit the cavity 23.

In addition, the forcing member 24 has an end provided with a seat 27 for the engagement of the manoeuvre equipment M.

In particular, the seat 27 is defined by a polygonal recess obtained at an end of the dowel screw and in which a polygonal key is inserted which constitutes the manoeuvre equipment M.

With particular reference to the embodiment represented in the attached figures, the stud body 16 and the corresponding abutment body 14 are of the anti-break-in type for door-leafs A of the slidable type.

The abutment body 14 is constituted by a counter-plate 140 which is intended to be fixed, for example through hooks 28, to the fixed framework of the door-leaf A.

The seat 17 is constituted by a slot which is obtained in the abutment body 14 and which has a first longitudinal portion with a larger transverse section and which is connected with a second longitudinal portion with smaller transverse section than the first one. The first longitudinal portion of such slot is dimensioned to allow the stud body 16 to pass through it when the door-leaf A is slid in closure position.

The second longitudinal portion of such slot is instead dimensioned to allow the sliding of the shank 15 (the sliding following the sliding of the plate or rod body controlled by a handle or the like) along it, but not the passage through it of the stud body 16, whose detachment in direction orthogonal to the plane defined by the counter-plate 140 is, thus, hindered by the obstacle so as to constrain the door-leaf A to the fixed framework.

The containment and guide body 12 is constituted by a C-shaped section having hook elements 29 for coupling to the channel of the section P and on whose back part an opening 30 is obtained in which, in mounting configuration, the shank 15 is slidably housed.

As instantly clear to a person skilled in the art, the shape of the stud body 16 and the corresponding abutment body 14 as represented in the attached figures are not limiting with respect to the present invention.

The stud body 16 and the corresponding abutment body 14 may actually be shaped differently with respect to the ones shown; in particular, they may not be of the anti-break-in type and they may be of the type applicable even to door-leafs of the non-slidable type, such as for example swing door-leafs or of the tilting type.

For example, the stud body 16 may be generally cylindrical-shaped and the seat 17 may be constituted by a U-shaped saddle obtained in a plate-like abutment body and in which the stud body 16 is inserted.

With reference to the FIGS. 1, 4, 5 and 6 the operation of the closing device 10 according to the present invention is here below described.

The closing device 10 is mounted on the frame T; in the case illustrated in the attached figures this occurs by mounting, in the channel C of the section P, the unit constituted by the containment and guide body 12 within which the plate or rod body 11 is slidably housed, on which plate or rod body 11 at least one closing member 13 is fixed whose shank 15 traverses the opening 30 to project outside with respect to it.

When the closing device 10 is in such mounting configuration it is possible to adjust the axial position of the stud body 16 along the shank 15 and, thus, it is possible to adjust the distance between the stud body 16 and the corresponding seat 17 of the relative abutment body 14 so as to eliminate possible clearances or errors for example due to an incorrect mounting of the door-leaf A and/or a incorrect assembly of the frame T which delimits the same door-leaf A and/or imperfect parallelism between the external edge of the frame T and the fixed framework or any other. For this purpose, after unlocking the stud body 16 through the locking and unlocking means 19—in this specific case, after unscrewing the dowel screw with the help of the manoeuvre equipment M—the adjustment of the position of the stud body 16 along the shank 15 is carried out by rotating the stud body 16 in one direction or in the opposite one.

After the stud body 16 is brought to the desired axial position along the shank 15, it is stably anchored and fixed to the shank 15 through locking and unlocking means 19. In this specific case, the forcing member 24 (i.e. the dowel screw) is inserted and screwed into the cavity 23 inside the shank 15 so as to force the radial expansion of the same shank 15 which, thus, is stably locked inside the stud body 16.

Thus, the stud body 16, and the “closure point” defined thereby, is stably secured and fixed in the desired position.

The person skilled in the art shall easily configure and dimension the shank 15, the stud body 16 and the forcing member 24 (i.e. the dowel screw) so as to obtain the above described expansion locking.

As mentioned above, the plate or rod body 11 is in turn connected to manoeuvring means, of the rod type, return means and the like, which for example can be controlled by rotating a handle and which allow sliding the plate or rod body 11 along the containment and guide body 12 in both directions so as to displace the respective closure members 13 between a closure position and an opening position and vice versa. In the closure position the stud body 16 of each closing member 13 is coupled with the respective seat 17 of the corresponding abutment body 14 so as to anchor the door-leaf A to the fixed framework of the door or window. In the embodiment illustrated in the attached figures, the stud body 16, following the sliding of the door-leaf A approaching the fixed framework, has traversed the slot which defines the seat 17 and, following the sliding of the plate or rod-like body 11, is arranged at the portion of such slot with smaller transverse section (and, in particular, smaller than the transverse dimension of the same stud body 16) so as to prevent, by hindering with the counter-plate, the moving of the door-leaf A away from the fixed framework.

In the position of opening, the stud body 16 of each closing member 13 is de-coupled by the respective seat 17 of the corresponding abutment body 14 to allow the movement of the door-leaf A with respect to the fixed framework of the door or window. With reference to the embodiment represented in the attached figures, the stud body 16, following the sliding of the plate or rod body 11 in direction opposite to the previous one, is at the portion of the slot which defines the seat 17 with larger transverse section (and, in particular, larger than the transverse dimension of the stud body 16 which, thus, may traverse the same slot), so as to release the door-leaf A from the fixed framework and thus allow the sliding in the moving away direction so as to open the door or window.

It should be observed that the coaxial arrangement of the shank, the stud body and the locking and unlocking means—specifically the forcing member of the radial expansion of the same shank inside the stud body—allows reducing the overall dimensions of each closing member in particular in the direction longitudinal to the plate or rod body.

This coaxial arrangement of the shank, the stud body and the locking and unlocking means—specifically the forcing member of the radial expansion of the shank into the stud body—allow accessing the latter locking and unlocking means from outside the closing device, even when the latter is in mounting configuration, in a simple and easy manner. In particular, this arrangement leaves enough space for adjustment operations carried out by the user through the manoeuvre equipment without the latter interfering with the section of the frame which delimits the door-leaf.

It has been observed that the closing device according to the present invention attains the proposed objects.

As a matter of fact, the closing device according to the present invention allows adjusting the position of the closure members (“closure points”) mounted on the door-leaf of a door or window with respect to the corresponding abutment bodies fixed to the fixed framework of the door or window or to the frame of another door-leaf adjacent to the first in case of a door or window with two slidable or swing door-leafs, so as to eliminate any relative positioning errors deriving from different structural or mounting reasons.

This adjustment can be executed in a simple and quick manner by a user with a limited number of operations whose execution is made particularly easy by the configuration and arrangement of the various elements (shank, stud body and locking and unlocking means) which form each closing member.

In addition, the closing device according to the present invention has small overall dimensions and guarantees a stable and safe fixing of the closure members on the respective plate or rod-like bodies.

The closing device for closing door-leafs of doors or windows thus conceived can be subjected to numerous modifications and variants, all falling within the scope of the invention; in addition, all details can be replaced by technically equivalent elements. In practice, the materials used, as well as the dimensions, may vary according to the technical requirements.

1) A closing device for closing door-leafs (A) of doors or windows comprising a plate or rod body, which can be associated in a movable manner with the frame (T) which delimits a door-leaf (A) of a door or window and which is connectable to maneuvering means that are controllable through a handle or the like, and a at least one closing member, which is fixed to said plate or rod body and which is adapted to be coupled with a corresponding abutment body that is fixable to the fixed framework of said door or window or to the framework that delimits another door-leaf of said door or window, wherein said closing member comprises:
a shank which is fixable to said at least one plate or rod body; and
a stud body which is coupled to said shank through coupling means which allow adjusting the position of said stud body along the longitudinal axis (B) of said shank, wherein said stud body is adapted to be coupled with a corresponding seat obtained in said abutment body.

2) The closing device according to claim 1, wherein said shank has a first end which is fixable to said at least one plate or rod body and a second end axially opposite to said first end, wherein, when said closing device is in mounting configuration on said door-leaf (A), said longitudinal axis (B) of said shank extends on a plane parallel to the plane defined by said door-leaf (A) and in a direction orthogonal to said plate or rod body so that second end of said shank extends towards the external edge of the frame (T) which delimits said door-leaf.

3) The closing device according to claim 1, further comprising means for locking and unlocking said stud body with respect to said shank and which are manoeuvrable by a user from outside said frame (T) which delimits said door-leaf (A).

4) The closing device according to claim 1, wherein said coupling means are of the threaded type.

5) The closing device according to claim 4, said shank has an external threading and in that said stud body is provided with a passing through axial hole that is internally threaded and in which said external threading of said shank is engaged.

6) The closing device according to claim 3, wherein said locking and unlocking means are coaxial to said shank.

7) The closing device according to claim 3, wherein said locking and unlocking means are of the expansion type.

8) The closing device according to claim 2, wherein said shank is expandable radially and it has an inner axial cavity which is open at said second end, wherein said locking and unlocking means comprises a forcing member for forcing the expansion of said shank, said forcing member being insertable in said cavity of said shank through the opening defined at said second end of said shank for forcing the radial expansion of the latter so as to lock it in said stud body.

9) The closing device according to claim 8, wherein said forcing member is constituted by a dowel screw which is engaged with a corresponding threading inside said cavity.

10) The closing device according to claim 8, wherein said forcing member has an end provided with a seat for the engagement of a maneuver equipment (M).

11) The closing device according to claim 8, wherein said shank has at least one groove, a longitudinal slit or slot.
